(19) United States
(12) Patent Application Publication
(10) Pub. No.: US 2011/0196759 A1
(43) Pub. Date: Aug. 11, 2011

(54) LEAD GENERATION MANAGEMENT SYSTEM

(75) Inventors: Jeff McCollum, Newport Beach, CA (US); Dave Stewart, Costa Mesa, CA (US); Harrison Spain, Tustin Ranch, CA (US)

(73) Assignee: ACCELERIZE NEW MEDIA, INC., Newport Beach, CA (US)

(21) Appl. No.: 13/020,240

(22) Filed: Feb. 3, 2011

Related U.S. Application Data
(60) Provisional application No. 61/301,811, filed on Feb. 5, 2010.

(51) Int. Cl. G06Q 30/00

(52) U.S. Cl. 705/26.35; 705/26.1

(57) ABSTRACT

A process for managing leads includes the steps of: presenting an offer to a potential customer; receiving personal information from the potential customer; verifying that the personal information came from a reliable source; checking the personal information for validity; analyzing contracts of companies looking to buy leads to determine if a potential buyer fits any criteria of any of the contracts; if at least one contract is not found, placing the potential buyer in a reprocessing pool; and if at least one contract is found, placing the potential buyer into a pool of a plurality of potential buyers. The process goes on to select a winner for a lead from the pool of potential buyers.

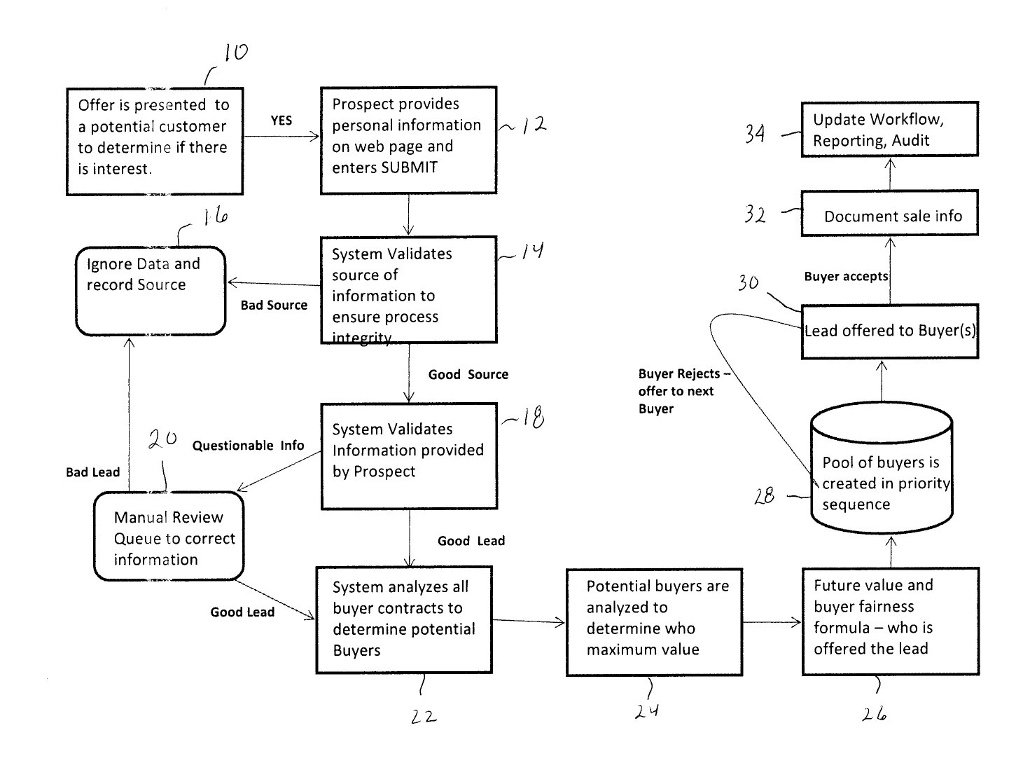

### CROSS-REFERENCE TO RELATED APPLICATION(S)

The instant application claims the benefit of provisional patent application No. 61/301,811, filed Feb. 5, 2010, entitled LEAD GENERATION MANAGEMENT SYSTEM.

### BACKGROUND

The present invention relates to a system and process for Internet advertising to define and manage online marketing campaigns and to optimize the value of potential customers (leads) for clients.

### SUMMARY OF THE INVENTION

In accordance with the instant invention, there is provided a system to be used with Internet advertising. The system defines and manages the online advertising campaigns. Further, the system accrues offers from buyers for information about potential customers (leads). The system then evaluates the offers to determine which ones would maximize the value of the potential customers.

In accordance with the present invention, there is provided a process for managing leads broadly comprising the steps of: presenting an offer to a potential customer; receiving personal information from the potential customer; verifying that said personal information came from a reliable source; checking said personal information for validity; analyzing contracts of companies looking to buy leads to determine if a potential customer fits any criteria of any of said contracts; if at least one contract is not found, placing the potential customer in a reprocessing pool; and if at least one contract is found, placing the potential customer into a pool of a plurality of potential buyers.

Other details of the system and process of the present invention are set forth in the following detailed description and the accompanying drawing.

### BRIEF DESCRIPTION OF THE DRAWINGS

The FIGURE is a flow chart showing the Internet advertising/lead generation management system of the present invention.

### DETAILED DESCRIPTION OF THE PREFERRED EMBODIMENT(S)

The system and process for Internet Advertising to define and manage online marketing campaigns and to optimize the value of potential customers (leads) for client may be implemented using any suitable processor or computer known in the art. The processor or computer is programmed to have a number of modules. The modules, which operate in real-time, include modules to receive leads from an Internet source; to validate the lead(s) are not fraudulent; to determine if anyone is interested in this lead type; to determine the pool of potential buyers for the lead; to determine the maximum value for the lead; to offer the lead to the best buyer; and to document the sale and record audit information.

The system also utilizes an intuitive user interface as well as proprietary software to minimize the requirement for clients to have technical computer staff employed to operate the system.

Referring now to the FIGURE, the process for managing lead generation begins in step 10 where an offer is presented to a potential customer using e-mail, Internet ad banners, and/or Internet ad pages. The offer is presented to determine if there is interest by a potential customer.

As shown in step 12, if interested, the potential customer provides personal information about himself/herself/themself. The personal information may include the customer's name, address, age, etc., as well as some required information specific to the Ad. For example, total amount owed on credit cards may be a field which the potential customer has to answer. After the potential customer has completed all required fields, he/she hits a submit key to transmit the information.

As shown in step 14, the system receives the submitted information and processes same to check whether the information came from a reliable Internet source or a potential fraudulent location. This is done to insure process integrity. If the source is deemed fraudulent, as shown in step 16, the information is ignored and information about the fraudulent site is recorded in a memory associated with the system's processor/computer. If the source is deemed reliable, the information is passed onto step 18.

In step 18, the personal information which has been provided for a customer is checked for valid name, address, phone number, etc. If the information is deemed questionable or fraudulent, the lead goes into a review queue in step 20 for manual processing and review. If the information is approved, the process moves onto step 22.

In step 22, the system performs a detailed analysis of all the contracts of companies looking to buy leads to determine if this individual/potential buyer fits the criteria of any contracts. The analysis may include such questions as: (a) is the buy flag on; (b) have the maximum number of leads been reached for the time period; (c) is it open/close time; (d) is it correct vertical (lead type); (e) what is the age of the lead; (f) what is the lead score bandwidth; (g) is the buyer financially approved (pre-paid or credit lines); (h) do vertical filters fit (min. debt/max debt); (i) was lead ever posted before; (j) blocks and allows for buyer to qualify for vertical; and (k) buyer takes upsell leads? If there are no contracts that match, then the lead is held to be reprocessed. If there are contracts that match, they are put into a pool for further analysis.

In step 24, the pool of potential buyers of the lead is analyzed to determine the maximum value which can be received for the lead currently. This module also checks for fairness, ensuring that buyers offering a lower amount per lead are treated fairly and provided opportunities to buy leads. Still further, the pool analyzing step comprises checking to see if any grouped buyers are part of a sell. Buyers are removed if group buyers are found in a sell. This module also checks to see if any of these buyers are sweepers to potentially swap out the lowest bidder if the resell limit has been hit; and add sweepers when there is room for them.

The module goes on to look for the highest exclusive buyer taking into consideration how many leads are already queued up for each buyer. Further, the module checks whether the multi-sell or exclusive sale is higher.

In step 26, there is applied a future value and buyer fairness formula to determine who is offered the lead. The pool of potential buyers at a future point in time is checked to determine if the lead is worth more if one waits to sell the lead. As the analysis is done for every lead against every buyer contract, there is the potential to have a lead qualify for multiple buyer contracts. A second analysis process is then triggered to determine which buyer is providing the best value for this lead at this exact point in time. There is a fine balance between selling the lead to make the most money and selling the lead to ensure that all buyers are being serviced.

In step 28, there are a number of factors that are scored to create a ranking list of buyers. These factors may include: (a) does a buyer buy this type of lead exclusively; (b) has the lead been sold before; (c) would the sale meet the margin which is needed; (d) are there buyers in different groups; (e) does the buyer have a priority contract; (f) is a weighted buyers list to be created; (g) is it a multi-sell (top X-weighted buyers, if one rejects goes to next in line); and (h) if all buyers reject, does the lead go back into the queue.

The buyer weighted rank for leads is a key control for lead sales. A formula may be used by the system which uses variables that are continuously being updated by the system to ensure that current information is always being used to determine the winning buyers. As can be seen in step 28, a pool of buyers is created in priority sequence.

To determine the winner between two buyers, each buyer's price may be weighted with the following formula:

Weighted Price=(Price Offered)×((1−(RT/120))×Response Time Weight)−((LD/LC)×Delivery Percentage Weight)−((PE/LD+PE+1)×Posting Error Weight),

where RT=Average Response Time in Seconds For Day;

LD=Leads Delivered for Day;

LC=Leads Delivery Cap for Day; and

PE=Posting Errors for Day.

Using this formula, one can ensure that buyers get an equal chance to receive leads in accordance with their relative prices, lead delivery caps, posting errors, and delivery times. Without this formula, buyers with higher prices will always win over a buyer with lower prices and leads will never be delivered to the lower priced buyer, given an insufficient number of leads. This will also ensure that, everything else being equal, two buyers with different sized lead caps will reach their limit at the same time, rather than the smaller buyers filling up first. The last part of the formula penalizes buyers for extensive post response times and post error responses. This will maximize profit on the lead by favoring buyers who allow for quicker delivery.

For any given lead that is run through a router, multiple sets of winning buyers are found for that lead. One in the current time frame, and buyers at set intervals up to two hours after the current time. If there is a set of buyers willing to pay more in a future time frame, the system will wait to sell that lead until that time. Due to the degraded nature of that lead because of age, the future buyer will have to pay a commensurately higher price.

As shown in step 30, winning buyers are notified primarily via an online POST to the buyer. However, notification can be done by e-mail for less sophisticated buyers. In the Online POST method, the lead offer which was sent is logged along with all the text, the time, etc. for a full audit log. Then, the system waits for a response from the potential buyer on accepting or rejecting the lead. If the buyer rejects, the offer goes to the next buyer in the pool. The fact that there was a rejection is documented.

When any response is received from the buyer, it is logged. In the case of a sale, sale information is inserted into the ledger for all information about the lead. Such information may include who bought it, how much, when it was bought, etc.

In step 32, all sale info is documented. It may be stored on a central database which is also used to drive the workflow management and reporting features performed in step 34. In this step, the workflow is updated, and reporting and audit functions may be carried out.

All of the process steps described herein may be carried out by a processor or a computer having suitable programming to perform the functions discussed hereinabove.

It is apparent that there has been provided herein a lead generation management system which increases the ability to define and manage online marketing campaigns and to optimize the value of potential customers (leads) for clients. While the lead generation management system has been described in the context of a specific embodiment thereof, other unforeseen alternatives, modifications and variations will become apparent to those skilled in the art having read the foregoing description. Accordingly, it is intended to embrace those alternatives, modifications, and variations as fall within the broad scope of the appended claims.

What is claimed is:

1. A process for managing leads comprising the steps of:
presenting an offer to a potential customer receiving personal information from the potential customer;
verifying that said personal information came from a reliable source;
checking said personal information for validity;
analyzing contracts of companies looking to buy leads to determine if a potential buyer fits any criteria of any of said contracts;
if at least one contract is not found, placing the potential buyer in a reprocessing pool; and
if at least one contract is found, placing the potential buyer into a pool of a plurality of potential buyers.

2. The process of claim 1, wherein said offer presenting step comprises presenting said offer via at least one of e-mail, Internet ad banners, and Internet ad pages.

3. The process of claim 1, wherein said personal information receiving step comprises receiving information about at least one of a customer's name, a customer's address, a customer's age, and total amount owed on credit cards.

4. The process of claim 1, wherein said verifying step comprises process the personal information to determine whether said personal information came from a reliable Internet source or a potential fraudulent location.

5. The process of claim 4, further comprising ignoring said personal information if the personal information came from a fraudulent location and recording said fraudulent location in a memory.

6. The process of claim 3, wherein said checking step comprises checking the validity of a customer's name, address, and phone number.

7. The process of claim 1, further comprising analyzing the pool of potential buyers to determine a maximum value which can be received for a current lead.

8. The process of claim 7, wherein said pool analyzing step further comprises checking for fairness so as to ensure that any buyer offering a lower amount per lead is treated fairly and provided opportunities to buy leads.

9. The process of claim 7, wherein said pool analyzing step comprises checking to see if any grouped buyers are part of a sell.

10. The process of claim 9, further removing buyers if grouped buyers are found in a sell.

11. The process of claim 9, further comprising determining if the buyer is a sweeper.

12. The process of claim 9, further comprising swapping out a lowest bidder if a resell limit has been hit.

13. The process of claim 9, further comprising adding sweepers when there is room.

14. The process of claim 7, further comprising making one of the buyers in the pool of potential buyers a temporary winner of the lead.

15. The process of claim 7, further comprising applying future value and buyer fairness parameters to determine who in the pool of potential buyers is offered the lead.

16. The process of claim 7, further comprising checking the pool of potential buyers at a future point in time to determine if the lead is worth more if one waits to sell the lead.

17. The process of claim 7, further comprising creating a ranking list of buyers.

18. The process of claim 17, further comprising determining a winner between two buyers.

19. The process of claim 18, wherein said winner determining step comprises weighting a price presented by each of said buyers using the formula:
Weighted Price=(Price Offered)×((1−(RT/120))×Response Time Weight)−((LD/LC)×Delivery Percentage Weight)−((PE/LD+PE+1)×Posting Error Weight),
Where RT=Average Response Time in Seconds For Day;
LD=Leads Delivered For Day;
LC=Leads Delivery Cap For Day; and
PE=Posting Errors For Day.

20. The process of claim 17, further comprising creating multiple sets of winning buyers and waiting to sell the lead at a time which would yield more money.
